(19) United States
(12) Patent Application Publication
(10) Pub. No.: US 2012/0008481 A1
(43) Pub. Date: Jan. 12, 2012

(54) OPTICAL PICKUP APPARATUS

(75) Inventor: Yoshihiro KIYOMURA, Fukuoka (JP)

(73) Assignee: PANASONIC CORPORATION, Osaka (JP)

(21) Appl. No.: 13/178,826

(22) Filed: Jul. 8, 2011

(30) Foreign Application Priority Data
Jul. 12, 2010 (JP) 2010-157458

(51) Int. Cl. G11B 7/00

(52) U.S. Cl. 369/100; G9B/7

(57) ABSTRACT

The present invention provides an electronic equipment which includes an optical member including a first adhesive application portion, wherein a support member is provided in which a second adhesive application portion is provided on a support surface of the optical member, a cross-sectional surface of the first adhesive application portion is opposite to a cross-sectional surface of the second adhesive application portion, a separation portion is provided between the first cross-sectional surface and the second cross-sectional surface, and a approximately spherical adhesive is fixed around an approximately center of the separation portion to include a part of the first and second adhesive application portions. Thus, an object is to provide electronic equipment that reduces deviation in the relative position between the optical member and the support member generated after the curing of the ultraviolet-curable adhesive.

### BACKGROUND

1. Field of the Invention

The present invention relates to an optical pickup apparatus that performs the playback or the recording of an optical disc such as a DVD, and an optical disc recording and playback apparatus equipped with the same.

2. Description of the Related Art

An optical pickup apparatus, which is mounted on an optical disc recording and playback apparatus for performing playback or recording of an optical disc such as a DVD, includes, for example, optical members as below. That is, the optical members are a laser diode that is a light source, an object lens that focuses laser on a disk, a lens holder that holds the object lens, a prism and a mirror that refracts and reflects laser, a light reception element that reads information from a disk surface or the like.

Regarding the joining of the optical members such an optical pickup and support members thereof by the use of an ultraviolet-curable adhesive, a variety of research has been performed from the past. For example, in JP-A-2003-337269, there is a description that shape retention of the required adhesive in a three-dimensional bonding of the optical element is maintained by setting a shape and a combination ratio of a filler to be combined to optimally maintain fluidity and viscosity of the adhesive. Such an adhesive has very satisfactory high transparency, low shrinkage, and high temperature stability. Furthermore, since such an adhesive can be cured in a short time while preventing peeling of the adhesive, productivity is significantly improved.

However, even if it is possible to cure the adhesive in a short time with such high shape retention, it was understood that, actually, the ultraviolet-curable adhesive is not necessarily uniformly and completely cured from the inner portion to the outer portion. In the boundary between the adhesive and the optical member or the support member, curing is delayed compared to the inner portion thereof or the curing is hard to perform. For that reason, even if the optical member and the support member of the optical pickup are adjusted to a predetermined relative position and then the adhesive is applied, and ultraviolet light exposure is sufficiently performed on the adhesive and then a fixing jig is removed, in the non-cured portion, even after the correction of the position of the optical member is finished and a chucking jig is removed, volume shrinkage or loosening of the adhesive occurs.

The degree of loosening or volume shrinkage of the adhesive differs for each position of the adhesive due to influence of gravity or irregularity of the temperature environment in each part of the adhesive. In addition, since the influence of the environment always varies, it is naturally predicted that the state of the volume shrinkage or loosening of the adhesive also differs for each part. For that reason, force acting from each part of the adhesive on the optical member or the support member of the optical pickup to be fixed by the adhesive is not identical, but always varies from the point in time when applying and solidifying the adhesive. Moreover, as a result, the optical member of the optical pickup to be adjusted to the predetermined position deviates from the original adjustment position. The positional deviation of the optical member increases the frequency of reading errors or writing errors of the optical disc by the optical pickup apparatus including the same and the optical disc recording and playback apparatus, and in the worst case causes a state making recording and playback of the disc impossible.

### SUMMARY

An object of the present invention is to reduce deviation in the relative position of a light reception element portion and a carriage of an optical disc recording and playback apparatus or an optical pickup apparatus to be mounted thereon, which is generated after the curing of the ultraviolet-curable adhesive, and improve the operation accuracy of the optical pickup apparatus and the optical disc recording and playback apparatus.

In order to achieve the object, according to the present invention, there is provided an optical pickup apparatus which includes a light reception element portion, and a carriage supporting the same, wherein a first adhesive application portion is provided on a support surface of the carriage, a second adhesive application portion is provided on the support surface of the light reception element portion facing the first adhesive application portion, the first and second adhesive application portions have a cylindrical shapes, a cylindrical cross-cross-sectional surface of the first adhesive application portion faces a cylindrical cross-cross-sectional surface of the second adhesive application portion, a separation portion is provided between the first cylindrical cross-cross-sectional surface and the second cylindrical cross-cross-sectional surface, and a spherical adhesive is fixed around a center of the separation portion to include a part of the first and second adhesive application portions.

Thus, the curing of the adhesive which is in the separation portion and the periphery thereof is not hindered. Moreover, a tip portion of the adhesive application portion penetrates into the adhesive after the curing. In this manner, the optical member can be rapidly fixed to the support member. In addition, by making the shape of the adhesive substantially spherical shape, it is possible to uniformize the state of volume shrinkage and loosening of the adhesive, and uniformize the force acting on the adhesive application portion from each part of the adhesive. Thus, it is possible to reduce deviation in the relative position between the optical member and the support member, improve the operation accuracy of the optical pickup apparatus and the optical disc recording and playback apparatus, and accurately perform recording and playback of the optical disc. That is, the frequency of reading errors or writing errors of the optical disc by the optical pickup apparatus and the optical disc recording and playback apparatus is reduced, whereby the stable recording and playback of the optical disc is possible.

### BRIEF DESCRIPTION OF THE DRAWINGS

FIG. 1 is a diagram in which an optical pickup apparatus in an embodiment of the present invention is viewed from an upper surface.

FIG. 2A is an enlarged view in which a light reception element portion of the optical pickup apparatus in an embodiment of the present invention is viewed from a side of the optical pickup apparatus.

FIG. 2B is an enlarged view in which a light reception element portion of the optical pickup apparatus in an embodiment of the present invention is viewed from an upper surface of the optical pickup apparatus.

FIG. 3 is an enlarged view of a portion around an adhesive shown in FIG. 2.

FIG. 4A is an enlarged view in which a light reception element portion of an optical pickup apparatus of the related art is viewed from a side of the optical pickup apparatus.

FIG. 4B is an enlarged view in which a light reception element portion of an optical pickup apparatus of the related art is viewed from an upper surface of the optical pickup apparatus.

FIG. 5 is a perspective view of a mold where a sample for adjusting the curing state of an inner portion of an ultraviolet-curable adhesive is made.

FIG. 6 is a diagram that shows an example of a photograph showing a thin film sample cut from the ultraviolet-curable adhesive, which is made by the use of the mold shown in FIG. 5, in units of thickness of 10 μm.

FIG. 7 is a graph that shows an example of an infrared spectroscopic spectrum obtained from the result in which an infrared spectroscopic analysis is performed on a thin film sample cut from the ultraviolet-curable adhesive, which is made by the use of the mold shown in FIG. 5, in units of 10 μm in thickness.

FIG. 8 is a diagram that shows an example of a graph in which light transmittance T in a wave number A is measured on a thin film sample which is cut from the ultraviolet-curable adhesive injected and cured in the mold shown in FIG. 5 in units of 10 μm in thickness.

FIG. 9 is a diagram that shows an example of a graph in which light transmittance T in a wave number B is measured on a thin film sample which is cut from the ultraviolet-curable adhesive injected and cured in the mold shown in FIG. 5 in units of thickness of 10 μm.

FIG. 10 is a diagram that shows an example of a graph in which light transmittance T in a wave number C is measured on a thin film sample which is cut from the ultraviolet-curable adhesive injected and cured in the mold shown in FIG. 5 in units of thickness of 10 μm.

FIG. 11 is a graph that shows a distribution of an light absorption correction value αQ of a wave number A calculated on a ¼ of a thin piece starting from an arbitrary angle, in the respective thin film samples which are cut from the ultraviolet-curable adhesive injected and cured in the mold shown in FIG. 5 in units of thickness of 10 82 m.

FIG. 12 is a graph that shows a distribution of an light absorption correction value α of a wave number A calculated on a ¼ of a thin piece starting from an arbitrary angle, in the respective thin film samples which are cut from the ultraviolet-curable adhesive injected and cured in the mold shown in FIG. 5 in units of thickness of 10 μm.

FIG. 13 is a graph that shows a distribution of an light absorption correction value α of a wave number A calculated on a ¼ of a thin piece starting from an arbitrary angle, in the respective thin film samples which are cut from the ultraviolet-curable adhesive injected and cured in the mold shown in FIG. 5 in units of thickness of 10 82 m.

### DETAILED DESCRIPTION

Hereinafter, an optical pickup apparatus of the present invention will be described based on the drawings. In addition, the embodiment described below is a desirable specific example of the present invention, and the limits on technically favorable conditions are described, but the scope of the present invention is not limited to the description of limiting the present invention in the following description and is not limited to the condition.

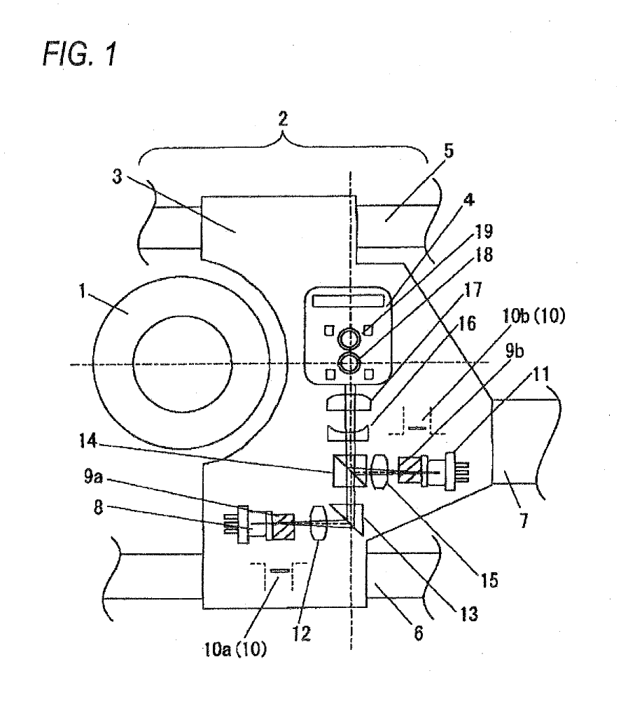

FIG. 1 is a diagram in which an optical pickup apparatus in an embodiment of the present invention is viewed from an upper surface thereof.

In FIG. 1, reference numeral 1 is a spindle motor for rotating an optical disc (not shown) mounted thereon. In the spindle motor 1, a chucking portion (not shown) is provided which holds the optical disc. The spindle motor 1 is able to rotate the optical disc at a constant angular velocity or rotate the optical disc with a variable angular velocity.

Reference numeral 2 is an optical pickup for writing information on an optical disc by irradiating the optical disc with light and reading information from the optical disc 1. Reference numeral 3 is a carriage which is a base of the optical pickup 2. Reference numeral 4 is an optical pickup actuator that moves an object lens described later three-dimensionally. The carriage 3 is supported by at least a support shaft 5 and a guide shaft 6, and is movable between the inner periphery and the outer periphery of the optical disc. In addition, the carriage 3 is equipped with the optical pickup actuator 4, and the optical portion or a light source, and is joined to a laser flexible substrate 7 by a solder or the like.

Reference numeral 8 is a blue laser portion, and reference numerals 9a and 9b are prisms. Reference numerals 10a and 10b are light reception element portions and will be described below in detail, but the basic configurations are identical to each other. Reference numeral 11 is a laser portion including two wavelengths of red and infrared, has a laser diode (not shown) emitting laser light of wavelength of about 660 nm and a laser diode (not shown) emitting laser light of wavelength of about 780 nm. The laser diodes are disposed in a sealed space.

Reference numeral 12 is a collimator lens for wavelength of 405 nm and is used to make the emitted laser light output from the blue laser portion 8 substantially parallel light. Furthermore, the collimator lens 12 also has a function of correcting a chromatic aberration generated due to the influence of wavelength fluctuation, temperature change or the like. Reference numeral 13 is a critical angle prism and is used for separating the laser light. Reference numeral 14 is a beam splitter, and is used for separating and joining the respective laser lights emitted from the blue laser portion 8 and the laser portion 11 including two wavelengths of red and infrared. Reference numeral 15 is a collimator lens for the wavelengths of 660 nm and 780 nm and is used for making the emitted light output from the laser portion 11 substantially parallel light. Furthermore, the collimator lens 15 is also able to have a function of correcting the chromatic aberration generated due to the influence of wavelength fluctuation, temperature change or the like.

Reference numeral 16 is a concave lens having negative power, and reference numeral 17 is a convex lens having positive power. Through the combination of the concave lens 16 with the convex lens 17, the laser light is expanded to a desired beam diameter. The laser light expanded to a desired beam diameter is introduced into an object lens described later by a start-up prism (not shown) corresponding to the blue laser light and the two wavelengths of laser light of red and infrared, respectively.

Reference numeral 18 is an object lens for an optical disc (DVD) corresponding to the wavelength of 660 nm and is an object lens having a function that can form a focus on a desired recording position by the parallel light even on the optical disc (DVD) correspond to the wavelength of 780 nm. Reference numeral 19 is an object lens for an optical disc (Blu-Ray or AOD) corresponding to the wavelength of 405 nm. In the present embodiment, the object lens 18 is disposed in the center position of the spindle motor, and the object lens 19 is disposed on the opposite side of the convex lens 17 relative to the object lens 18, that is, in a tangential direction to the optical disc 1. Furthermore, the thickness of the object lens 19 is configured so as to be thicker than that of the object lens 18.

In the present embodiment, in the case of recording or playing the Blu-Ray or AOD, the blue-violet laser light emitted from the blue laser portion 8 is converted into parallel light by the prism 9a and the collimator lens 12, passes through the critical angle prism 13, the beam splitter 14, the concave lens 16, and the convex lens 17, is led to the object lens 19 by a start-up prism (not shown), which is in the lower portion of the optical pickup actuator 4, and is focused onto an optical disc (Blu-Ray or AOD) (not shown) which is in the upper portion of the optical pickup actuator 4. Moreover, the light reflected from the information pit on the optical disc is led to the light reception element portion 10a by the prism 9a via each optical component in reverse order of the above. In this manner, recording or playback of the optical disc is performed.

The case of recording or playing the DVD or the CD is also substantially the same as the above. That is, the red laser light emitted from the light source 11 is converted into the parallel light by the prism 9b and the collimate leans 15, passes through the beam splitter 14, the concave lens 16, and the convex lens 17, is led to the object lens 18 by a start-up prism (not shown) in the lower portion of the light pickup actuator 4, and is focused onto an optical disc (a DVD or CD) (not shown) that is in the upper portion of the light pickup actuator 4. Moreover, the return light of laser reflected by the information pit on the optical disc is led to the light reception element portion 10b by the prism 9b via the respective optical components in reverse order of the above.

In the configuration described above, characteristic portions according to the present invention will be described from this.

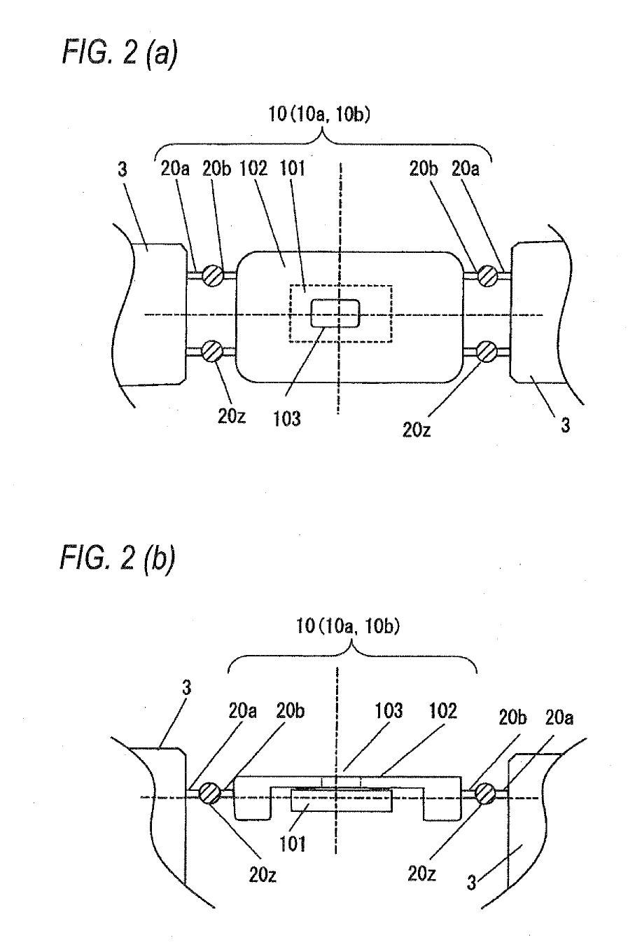

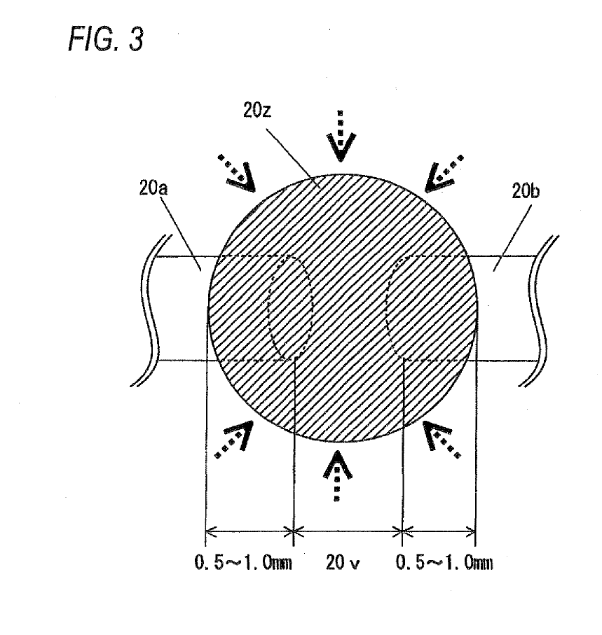

FIG. 2A is an enlarged view in which a light reception element portion of an optical pickup apparatus of an embodiment of the present invention is viewed from a side of the optical pickup apparatus. FIG. 2B is an enlarged view in which a light reception element portion of an optical pickup apparatus of an embodiment of the present invention is viewed from an upper surface of the optical pickup apparatus. In FIGS. 2A and 2B, light reception element portions 10a and 10b have basically identical configuration and are configured by a light reception element 101 and a light reception element holder 102. For that reason, in the future description, the light reception element portions 10a and 10b are collectively indicated as “light reception element portion 10”. A window 103 for allowing laser light to pass therethrough is opened in a light reception element holder 102, and the laser light reflected by the prism 9a or 9b passes through the window 103 and reaches light reception element 101.

In the present embodiment, when bonding and fixing the light reception element portion 10 and the carriage 3 using the ultraviolet-curable adhesive 20z, four cylinders 20a and 20b made of zinc alloy (ZDC2) having a length of about 3 mm and within a diameter range of from 0.1 mm to 3.0 mm are soldered in the carriage 3 or the light reception holder 102 (both of them are made of ZDC2) in the position shown in FIGS. 2A and 2B, respectively, in advance. The light reception element holder 102 and the light reception element 101 made of ZDC2 are bonded by the use of the ultraviolet-curable adhesive 20z. This will be described later in detail.

The light reception element portion 10, in which the light reception element 101 is bonded to the light reception element holder 102, is preliminarily fixed in the state of being adjusted in the vicinity of a predetermined relative position near the carriage 3 by a chucking jig (not shown). Moreover, the correction of the position of the light reception element portion 10 is performed by the fine adjustment of the chucking jig so that the blue laser portion 8 or 11 is oscillated, and the reflected light, which is returned from the disk through the optical path mentioned above and is guided by the prism 9a or 9b, passes through the window 103 and comes into contact with the center position of the light reception element 101.

Herein, when preliminarily fixing the light reception element portion 10 in the first place, the distance between an end portion of the cylinder 20a provided in the carriage 3 and an end portion of the cylinder 20b provided in the light reception element holder 102 of the counterpart light reception element portion 10 is about 1 mm, respectively. Moreover, after performing the fine adjustment of the light reception element portion 10 to correct the position, the distance between the end portion of the cylinder 20a and the end portion of the cylinder 20b is within a range larger than 0 mm and less than 2 mm.

In this manner, in the state in which the light reception element portion 10 is minutely adjusted, the ultraviolet-curable adhesive 20z is applied so as to wrap the end portion of the cylinder 20a provided in the carriage 3 and the end portion of the cylinder 20b provided in the counterpart light reception element portion 10 by the use of a dispenser.

As the dispenser, AD2000C produced by IWASHITA INSTRUMENT is used, the air pressure thereof is 0.4 Pa, and the time of one shot is 0.2 seconds. As the ultraviolet-curable adhesive 20z, for example, a commercially available adhesive is used in which, for example, viscosity at 25° C. is within the range from 15 Pa·s to 40 Pa·s. Since the adhesive, in which viscosity of the ultraviolet-curable adhesive at 25° C. is less than 15 Pa·s, is transmitted over time through the cylinder 20a and the cylinder 20b and the soaks outward after being applied to a predetermined position in a predetermined amount, it is difficult to form an approximately spherical shape. Furthermore, since the adhesive, in which viscosity of the ultraviolet-curable adhesive at 25° C. exceeds 40 Pa·s, has no fluidity upon being applied to a predetermined position in a predetermined amount, it is difficult to form an approximately spherical shape.

FIG. 3 is an enlarged view of a portion around the adhesive 20z shown in FIG. 2. As described using FIG. 2, when preliminarily fixing the light reception element portion 10 in the first place in FIG. 3, the distance between the end portion of the cylinder 20a provided in the carriage 3 and the end portion of the cylinder 20b provided in the counterpart light reception element holder 102, that is, the distance of a gap 20v, is about 1 mm. Moreover, after performing the fine adjustment of the light reception element portion 10 to correct the position, the distance of the gap 20v is within a range greater than 0 mm and smaller than 2 mm. When applying the ultraviolet-curable adhesive 20z so as to become a predetermined volume, the ultraviolet-curable adhesive 20z forms an approximately spherical shape due to surface tension and viscosity. The surface of the ultraviolet-curable adhesive 20z is applied to cover a portion of about 0.5 mm to 1.0 mm from the end portion of the cylinder 20a provided in the carriage 3 to the carriage 3 side supporting the same. Furthermore, the surface of the ultraviolet-curable adhesive 20z is applied to cover a portion of about 0.5 mm to 1.0 mm from the end portion of the cylinder 20b provided in the optical element holder 102 to the carriage 3 side supporting the same.

Actually, the ultraviolet-curable adhesive 20z is not necessarily uniformly and completely cured from the inner portion to the outer portion. An interface between the cylinder 20b provided in the light reception element portion 10 as an optical member and the cylinder 20a provided in the carriage 3 as a support member is slowly cured or is difficult to cure. In the non-cured portion, even after completing the correction of the position of the light reception element portion 10 to remove the chucking jig, the volume shrinkage or release of the adhesive is always generated. However, if the configuration of FIG. 3 is adopted, it is possible to minimize the influence of the non-cured portion. The reason will be described later.

As an ultraviolet irradiator for optically curing the adhesive 20z applied so as to contain the end portion of the cylinder 20a and the end portion of the cylinder 20b, a spot cure SP-V manufactured by Ushio Electric is used. The distance from the exposure head to the ultraviolet-curable adhesive 20z is about 30 mm, and light is exposed for a time when the light exposure amount upon being measured by an UV actinometer UIT manufactured by Ushio Electric is 6,000 mJ/cm². In this manner, the light reception element portion 10 is mainly fixed to the carriage 3. After that, a chucking jig (not shown) is removed.

Next, a method of obtaining a distance, by which the light reception element portion 10 of the bonded and fixed optical pickup 2 shown in FIG. 1 is moved from an original position, will be described. In the present embodiment, the distance will be referred to as a “movement distance of the light reception element portion 10” as described later. That is, the distance is a distance by which, a chucking jig (not shown) is removed from the light reception element portion 10, the optical pickup 2 equipped with the light reception element portion 10 is preserved in the atmosphere of 60° C. for 100 hours, and then, the center of light contacting the light reception element 101 of FIG. 3 is moved from the original position.

An area, where the light reception element 101 can receive light, is a range of 3 μm from the center position in a vertical direction and a horizontal direction, respectively, but the movement of the center position of the spot of light contacting the light reception element 101 is allowed within the range of 2 μm vertically and horizontally in view of the configuration of the optical pickup.

In addition, in the present embodiment, only the movement distance in the vertical direction relative to an incident direction of the laser light onto the light reception element 101 was measured. Since the focal depth of the laser light is deep and the movement of about 10 μm is also allowed, the movement of the laser light to the light reception element 101 is excluded from the calculation of the movement direction of the light reception element 101 in the present embodiment.

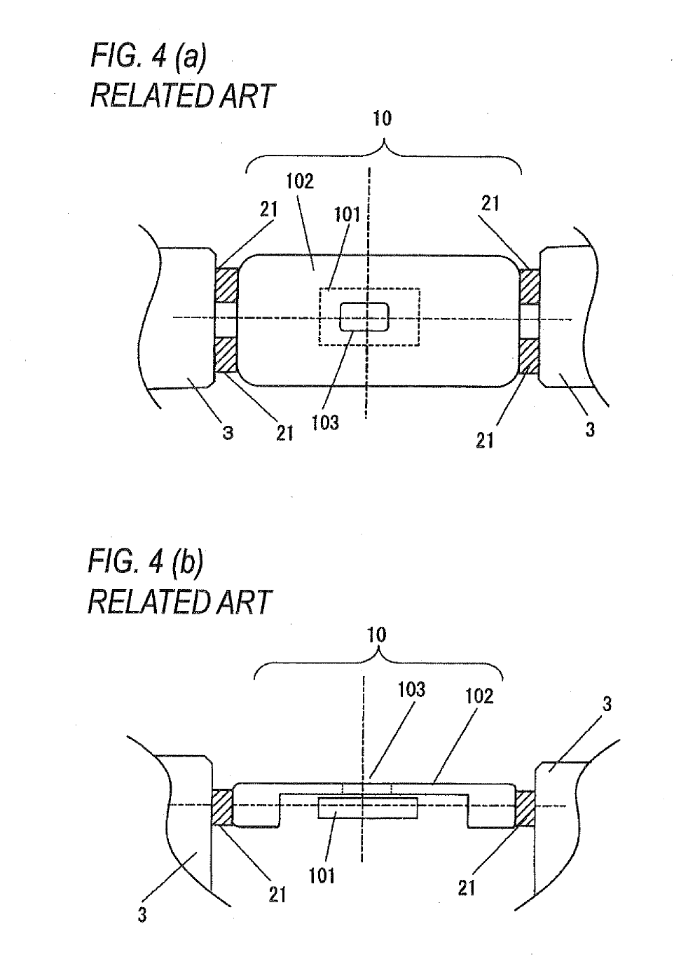

On the contrary to this, in the related art, as shown in FIG. 4, when bonding and fixing the light reception element 102 and the carriage 3 using the ultraviolet-curable adhesive 21, a method is used in which a separation portion is provided where the distance between the plane of the end portion of the light reception element holder 102 and the plane of the end portion of the carriage 3 is opened by about 1 mm, and the ultraviolet curable-adhesive 21 is injected, bonded and fixed to a part of the separation portion by the use of the dispenser. By providing the separation portion between the plane of the end portion of the light reception element holder 102 and the plane of the end portion of the carriage 3, the position of the light reception element 101 can be moved, whereby it is possible to bond and fix the light reception element in a position, where light led by the prism 9a or 9b is received, through the use of the ultraviolet-curable adhesive 21.

When bonding and fixing the light reception-element holder 102 and the carriage 3 by the aforementioned method by the use of the ultraviolet-curable adhesive 21, the shape of the applied ultraviolet-curable adhesive 21 forms a cylindrical shape or a polygonal column shape that interfaces the plane of the end portion of the light reception element holder 102 and the plane of the end portion of the carriage 3. The ultraviolet-curable adhesive 21 applied to the shape of cylinder or the polygonal column is exposed by a predetermined condition and is cured using an ultraviolet irradiation apparatus, which makes it possible to bond and fix the light reception element holder 102 and the carriage 3.

In the optical pickup manufactured by such a method, after exposing the ultraviolet-curable adhesive 21 for a predetermined time, when the chucking jig preliminarily fixing the light reception element holder 102 is removed, in some cases, the center position of the spot of light contacting the light reception element 101 is moved from the original position by 2 μm or more. Furthermore, even when the movement of the center position of the spot of light contacting the light reception element 101 from the original position is within 2 μm, after the optical pickup bonded with the light reception element 101 is preserved in the atmosphere of 60° C. for 100 hours, in some cases, the center position of the spot of light contacting the light reception element 101 is moved from the original position by 2 μm or more.

The inventor considered that the cause, in which the center position of the spot of light contacting the light reception element 101 mentioned above is moved from the original position by 2 μm or more, is influenced by the curing state of the inner portion of the ultraviolet-curable adhesive, and eagerly examined a method of evaluating the state. The method of evaluating the state of the curing in the inner portion of the adhesive and the evaluation result thereof will be described later.

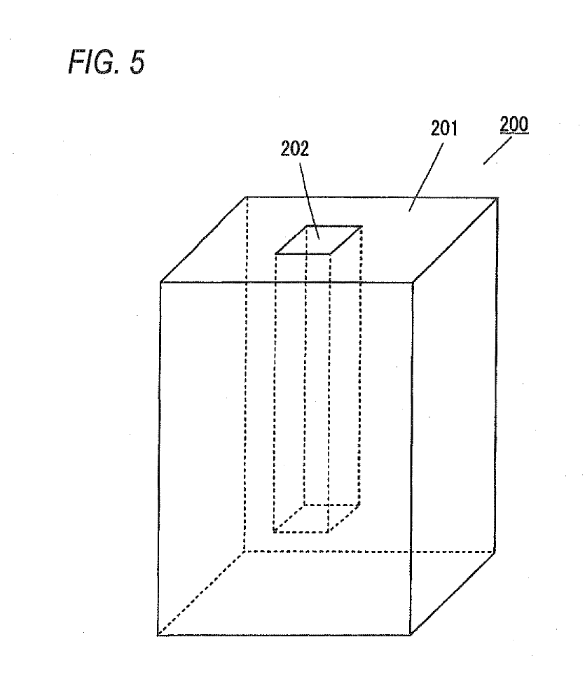

FIG. 5 is a perspective view of a mold that makes a sample for adjusting the curing state of the inner portion of the ultraviolet-curable adhesive. The mold 200 cures the black epoxy resin and has an external shape of 5 mm×5 mm×10 mm. Moreover, in the center portion of the upper surface 201 of the 5 mm×5 mm, a hole portion 202 having a depth of 10 mm having an aperture of 1 mm×1 mm is provided.

In order to obtain the sample for adjusting the curing state of the inner portion of the ultraviolet-curable adhesive using the mold 200 as above, the operation may be performed as below. That is, firstly, the ultraviolet-curable adhesive is injected into the center of the hole portion 202 of the mold 200 using the dispenser. Next, the adhesive attached to the operating portion of the hole portion 202 is scraped so that the exposed surface of the adhesive injected into the hole portion 202 and the upper surface 201 of the mold 200 are parallel to each other. After that, the mold 200, to which the adhesive is injected, is disposed in the ultraviolet irradiator so that the ultraviolet rays vertically come into contact with the exposed surface (that is, the upper surface 201 of the mold 200) of the adhesive, and the light is exposed by the time when the exposure amount is 6000 mJ/cm². Moreover, the mold 200 after the exposure is injected into the hole portion 202, and the thin film is cut in units of with a thickness of 10 μm from the side of the exposure surface (that is, the upper surface 201 of the mold 200 as the exposed surface of the adhesive) together with the adhesive cured by the exposure. Finally, the portion of the mold frame is removed from each thin film, and a sample for adjusting the curing state of the inner portion of the ultraviolet-curable adhesive having a square shape of 1 mm×1 mm is obtained.

Next, in regard to each thin film sample of the ultraviolet-curable adhesive obtained as above, the curing states of the respective inner portions were analyzed using a microscopic FT-IR and a microtome.

Firstly, the infrared spectroscopic analysis in the surface of the cut 1 mm×1 mm thin film using the microscopic FT-IR was performed. The aperture size was 25×25 μm, the square shaped thin film was put on the KBr plate having a diameter of 13 mm and a thickness of 1 mm and set on a sample table (an auto stage) of the microscopic FT-IR, two adjoining sides of the square shaped thin film were matched in the XY direction of the auto stage, the analysis area (the aperture size) is 25 μm×25 μm, and the infrared spectroscopic analysis was performed for each 25 μm pitch from one corner of the square shaped thin film in the XY direction, respectively.

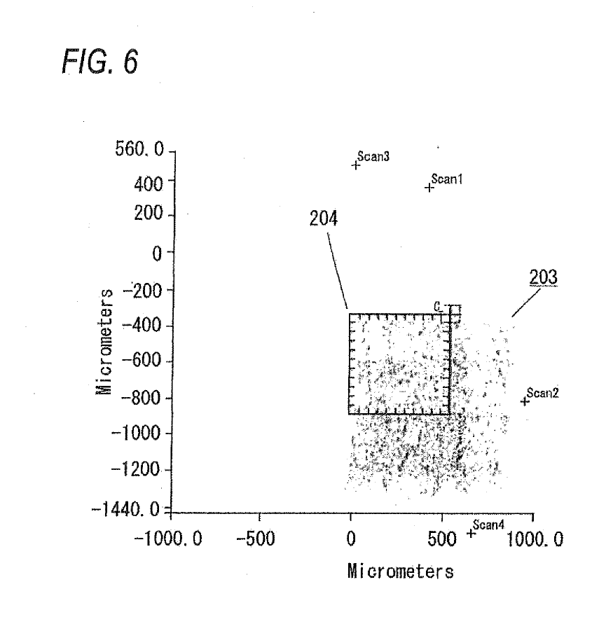

FIG. 6 is an example of a photograph that shows the thin film sample cut from the ultraviolet-curable adhesive, which is injected in the mold shown in FIG. 5 and cured, in units of 10 μm in thickness. Among the thin film sample 203 having a size of about 1 mm×1 mm, an area 204 in a square frame having the size of about ¼ as a starting point of an arbitrary angle was subjected to the infrared spectroscopic analysis.

The condition of the infrared spectroscopic analysis of this time is as shown later. That is, the measurement mode is a transmission mode, the wave number of the measurement wavelength region is 800 to 2000 cm⁻¹, the resolution is 4 cm⁻¹, and the number of scans is 4.

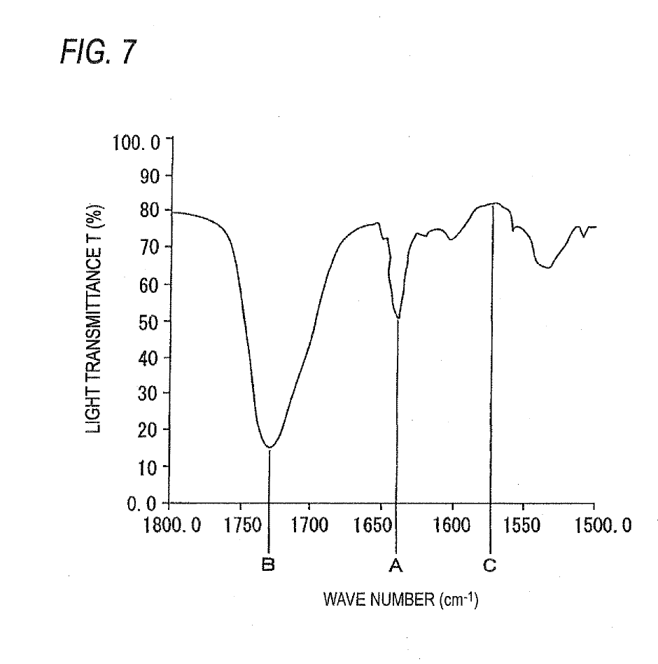

FIG. 7 is a graph that shows an example of the infrared spectroscopic spectrum which is obtained as a result of performing the infrared spectroscopic analysis on the thin film sample cut from the ultraviolet-curable adhesive injected into the mold shown in FIG. 5 and cured in units of 10 μm in thickness. A transverse axis is a wave number (unit cm⁻¹) and a longitudinal axis is a light transmittance T. When the thickness of the thin film sample is set to L and the concentration of the adhesive is set to C, the relationship between the light transmittance T and the light absorption a is as shown in the following formula (1).

T=exp(−αLC) (formula 1)

Herein, for example, the wave number 1639 cm⁻⁴ showing the peak of the absorption of vinyl group, that is, the light absorption αA of the wave number A in FIG. 7 is required. This is because the amount of vinyl group is closely related to the degree of the curing of the adhesive. A large amount of the vinyl group shows that the adhesive is not sufficiently cured. When the amount of the vinyl group is high, the absorption ratio of light having the end number A is increased, and the value of the light absorption a is increased. Thus, in this case, the light transmittance of the wave number A in FIG. 7 is lowered.

However, actually, the thicknesses of the thin film samples are not constant to 10 μm, but are slightly different from each sample. Thus, in order to normalize the same to purely extract the influence due to the degree of the curing, normalization is performed using a wave number B (for example, the wave number 1725 cm⁻¹ showing the peak of the absorption of carbonyl group)that shows the absorption not involved in the curing state of the ultraviolet-curable adhesive, and the light absorption αB and αC of the wave number C in which the absorption by the ultraviolet-curable adhesive is not observed in the measurement wave number region. The light absorption is nearly unchanged among the thin film samples, which have the same thickness and only differs in curing state, and is a value that is simply changed by the thickness of the thin film sample. Thus, an light absorption correction value αQ of the normalized wave number A is obtained by the next formula (2).

αQ=(αA−αC)/(αB−αC) (formula 2)

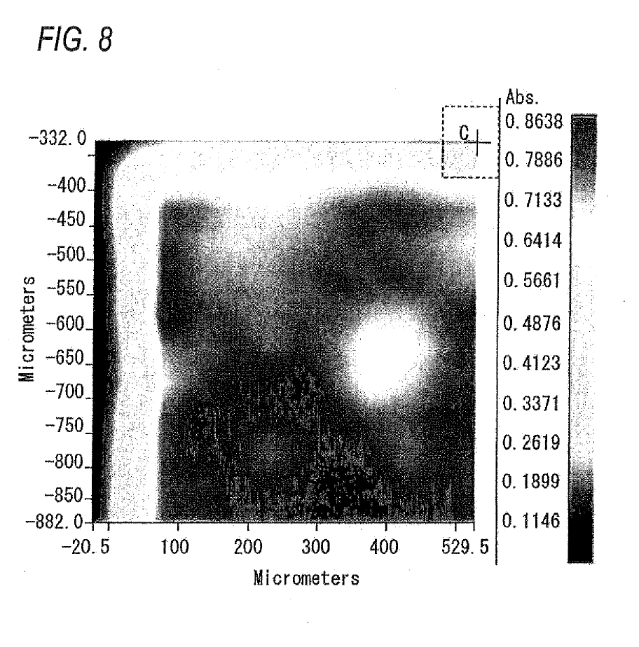

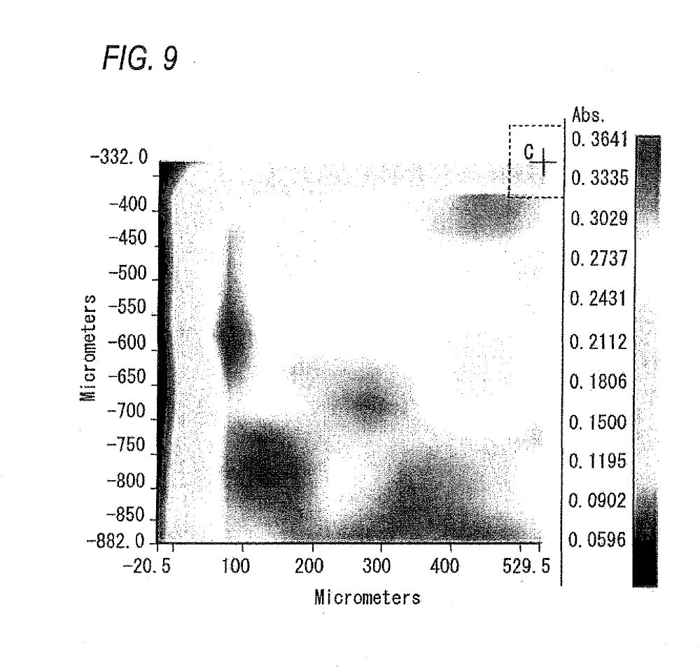

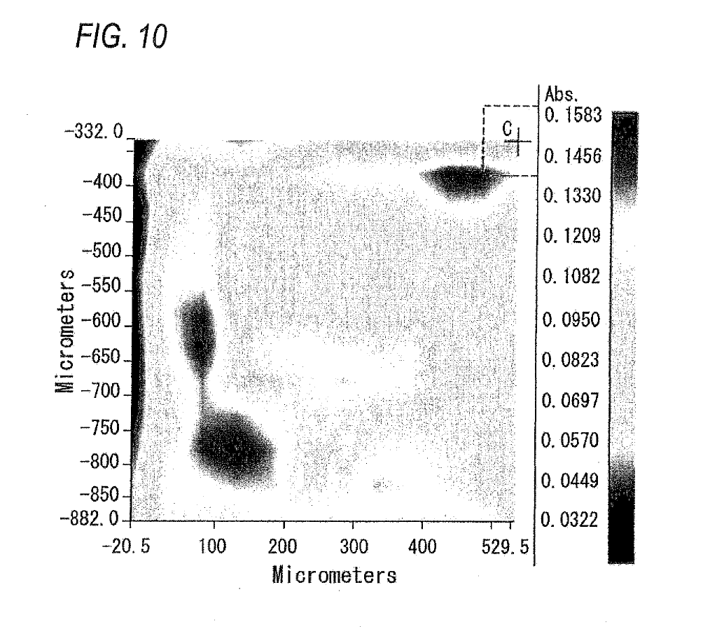

FIGS. 8 to 10 are examples of graphs in which the light transmittance T in the wave numbers A, B and C are measured on the thin film sample cut from the ultraviolet-curable adhesive, which is injected into the mold shown in FIG. 5 and cured, in units of 10 μm in thickness. The longitudinal axis and the transverse axis show the coordinates on the thin film sample to be measured, and the shading of the graph shows the light transmittance in each wave number. The light absorption correction value αQ of the wave number A shown in the above formula (2) is obtained based on the light transmittance in the wave numbers A, B, and C in each part measured by the graph.

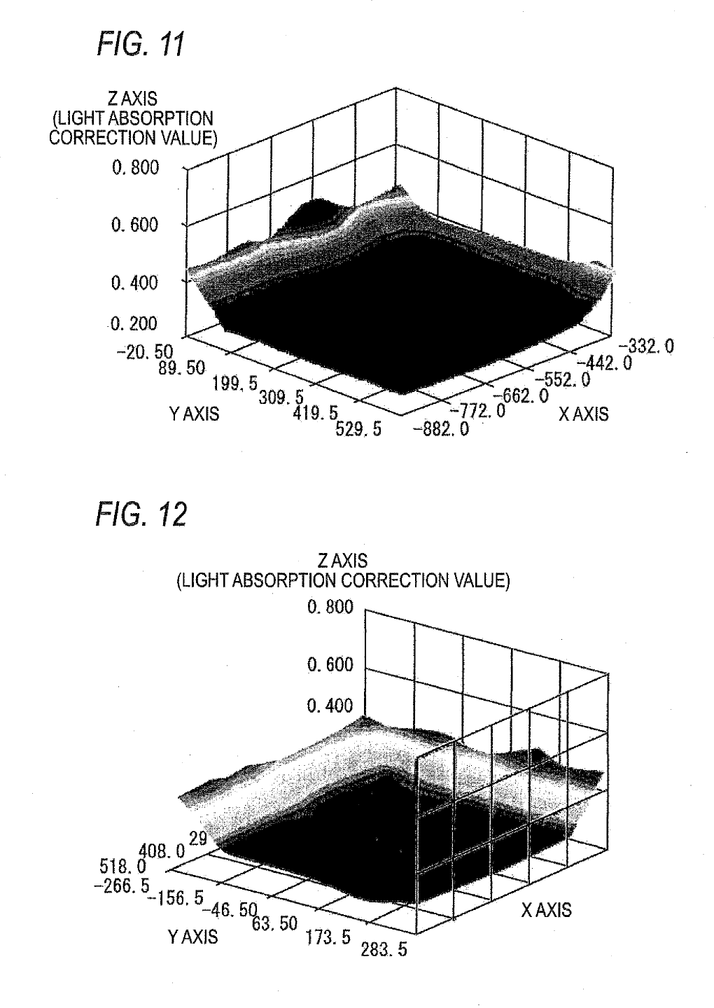

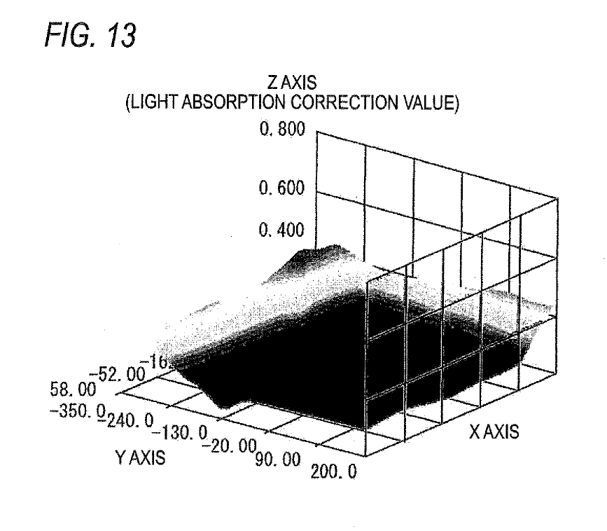

FIGS. 11 to 13 are graphs that show the distribution of the light absorption correction value αQ of the wave number A calculated on the 114 of a thin piece as a starting point of an arbitrary angle in the respective thin film samples cut from the ultraviolet-curable adhesive, which is injected into the mold shown in FIG. 5 and cured, in units of 10 μm in thickness. FIG. 11 is one cut from near the surface of the exposure surface by microtome, FIG. 12 is one cut from near the depth of 500 μm from the surface by microtome, and FIG. 13 is one cut from near 1,000 μm by microtome. The values of the first angle portions when viewed from the front of FIGS. 11 to 13 show the light absorption correction values of the wave number A in the center portion of the adhesive in the state of being injected into the hole portion 202 of FIG. 5 and cured. Moreover, the values in three angle portions and the side connecting the same in FIGS. 11 to 13 show the light absorption correction value of the wave number A in the bonding interface of the mold 200 and the adhesive injected into the hole portion 202 of the mold 200 of FIG. 5 and cured. In addition, in the case of closely examining the values, the ultraviolet-curable adhesive makes the liquid state enter a completely non-cured state and is based on the light absorption correction value 0.52. The data exceeding the value is decided to not be a region to be essentially measured and is excluded from the observation target.

As shown in any one of FIGS. 11 to 13, the light absorption correction value of the wave number A in the vicinity of the bonding interface with the mold 200 of the adhesive injected into the hole portion 202 and cured tends to be larger than that in the center portion of the adhesive. That is, this shows that the adhesive is not sufficiently cured in the vicinity of the bonding interface between the adhesive and other members as compared to the inner portion of the adhesive.

Based on this circumstance, returning to FIG. 4, the light reception portion of the optical pickup according to the bonding method of the related art will be observed. The light reception portion 10 is fixed to the carriage 3 only by the adhesive 21. Other configurations are the same as those of the optical pickup apparatus in an embodiment of the present invention shown in FIGS. 1 and 2.

In the related art, it was considered that the ultraviolet-curable adhesive 21 is relatively cured up to the bonding interface. The bonding method of the light reception element portion 10 as the optical member shown in FIG. 4 is devised based on this.

However, as confirmed by the test described using FIGS. 5 to 13, the ultraviolet-curable adhesive 21 is not uniformly and completely cured from the inner portion to the outer portion. The interface between the adhesive 21 and the light reception portion 10 as the optical member or the carriage 3 as the support member is slowly cured or difficult to cure. In the non-cured portion, even after the correction of the position of the light reception element portion 10 is finished and the chucking jig is removed, the volume shrinkage or release of the adhesive 21 is always generated. For that reason, even when the light reception element portion 10 of FIG. 4 as the optical member as the optical pickup 2 (see FIG. 1) and the carriage 3 as the support member are adjusted to a predetermined relative position and then the adhesive 21 is applied, and the ultraviolet exposure is sufficiently performed on the adhesive 21 and then the chucking jig is removed, the volume shrinkage or release of the adhesive 21 is generated in the non-cured portion.

The state or degree of the volume shrinkage or release of the adhesive 21 is different from each part of the adhesive 21 due to the influence of gravity or the irregularity of the temperature environment in each part of the adhesive 21. In addition, since the influence of the environment always varies, it is naturally predicted that the state of the volume shrinkage or release of the adhesive 21 is different from each part. For that reason, the force acting on the light reception element portion 10 of FIG. 4 as the optical member of the optical pickup 2 (see FIG. 1) fixed by the adhesive 21 or the carriage 3 as the support member by each part of the adhesive 21 is not identical but always varies from the point in time when applying and solidifying the adhesive. Moreover, as a result, the light reception element portion 10 of FIG. 4 as the optical member of the optical pickup (see FIG. 1) adjusted to a predetermined position deviates from the original position. The positional deviation in the optical member, that is, the light reception element portion 10 increases the frequency of reading errors or writing errors of the optical disc by the optical pickup apparatus and the optical disc recording and playback apparatus including the same, and in the worst case, the recording and playback of the disk itself are impossible.

Particularly, in FIG. 4, the curing of the bonding interface between the adhesive 21 and the light reception element holder 102 of the light reception element portion 10 or the carriage 3 is weakened. That is to say, the curing near the bonding interface between the adhesive 21 and the light reception element holder 102 or the carriage 3 is not sufficiently performed compared to the inner portion thereof. For that reason, even when the light reception element portion 10 is preliminarily fixed using the chucking jig to perform sufficient exposure, the probability increases that the light reception element portion 10 will greatly move from the position originally adjusted after the removing the chucking jig. That is, when the curing state in the adhesive 21 is insufficient, it is expected that the mechanical strength of the adhesive 21 will deteriorate, the fixing position of the light reception element portion 10 is changed by the dead weight of the light reception element portion 10 itself or an external pressure due to deflection of an accompanying flexible wiring plate or the like, and the function of the optical member cannot be exhibited. Furthermore, it is expected that the fixing position of the light reception element portion 10 changes due to environmental changes such as temperature and humidity, and the function cannot be sufficiently exhibited.

The reason why the state of curing in the vicinity of the bonding interface between the ultraviolet-curable adhesive 21 and the light reception element portion 10 or the carriage 3 is insufficient is not yet completely clear, but the reason is considered as below. That is, the ultraviolet rays irradiated to the adhesive 21 is absorbed to the inner portion of the adhesive, a photoinitiator to be contained in the adhesive is activated, an active species is generated and is polymerization-reacted with the resin component (monomer or oligomer) around the active species, and the polymerization reaction is chained, whereby the curing of the ultraviolet-curable adhesive 21 proceeds. Since the resin components pull each other in the process of polymerization, as a result, the volume of the adhesive 21 is slightly shrunk. However, in the vicinity of the bonding interface between the adhesive 21 and the light reception element holder 102 of the light reception element portion 10 or the carriage 3, the movement of the molecules of the adhesive 21 attached to the interface deteriorates by inter-molecular force generated between the metal molecules constituting the light reception element holder 102 or the carriage 3. As a result, the polymerization with another resin component generated in the adhesive 21 is inhibited, the shrinkage does not proceed, and the curing is not sufficiently performed. Thus, it is considered that the strength of the adhesive near the bonding interface is weakened, and the fixed light reception element portion 10 is moved.

Based on the tests and observations mentioned above, in the present invention, as shown in FIGS. 2 and 3, the light reception element portion 10 as the optical member and the carriage 3 as the support member supporting the same are bonded and fixed by the cylinders 20a and 20b and the ultraviolet-curable adhesive 20z as below. That is, by including the cylinders 20a and 20b and performing the bonding so as to include the bonding interface in the adhesive 20z, the area of the bonding interface with the adhesive 20z is reduced, the exposure area of the adhesive 20z is increased, and the curing of the adhesive 20z proceeds sufficiently. As a result, the shrinkage as shown in FIG. 3 by a thick dotted-line arrow is generated in the adhesive 20z. Moreover, if sphericity of the adhesive 20z is high, the shrinkage is approximately equally generated over the entire periphery of the adhesive 20z. If the end portions of the cylinders 20a and 20b sufficiently enter the inner portion of the adhesive 20z, by the shrinkage force which is approximately equally generated all over the periphery of the adhesive 20z, the light reception element portion 10 is reliably fixed to the carriage 3 via the cylinder 20b, the adhesive 20z and the cylinder 20a. As a result, the mechanical strength is given to the adhesive 20z, and the accuracy of the fixing position of the light reception element portion 10 is increased, whereby it is possible to accurately perform recording and playback of the optical disc.

In addition, concerning how much the end portions of the cylinders 20a and 20b in FIG. 3 are inserted into the inner portion of the adhesive 20z to a minimum, there is a need to consider shrinkage due to the curing of the adhesive 20z. The volume shrinkage due to the curing of the adhesive 20z is about 5 to 10%. If the volume shrinkage is 10%, that is the volume of 90% before the curing. The volume of an approximately spherical adhesive 20z having a radius r is cube root or 4π(r̂³)/³. Thus, the description that the volume after the curing is 90% before the curing means that the radius after curing is about 96.5% before curing. For example, when the volume of the adhesive 20z is 4.5 mm³, the shrinkage of the adhesive 20z in the radial direction is about 35 μm. Thus, the end portions of the cylinders 20a and 20b can theoretically fix the cylinders 20a and 20b even when the adhesive 20z is cured, if the end portion is at least included in the inside from a portion in which the shrinkage due to the curing of the adhesive 20z is expected at the point in time before the curing of the adhesive 20z. In the present embodiment, based on the situation, the mechanical strength required for supporting the light reception element portion 10 and the message securing the position adjustment margin of the light reception element portion 10 are further held, and the end portions of the cylinders 20a and 20b are included in the adhesive 20z by 0.5 mm to 1 mm.

### First Embodiment

As shown in FIG. 2, four cylinders 20a made of ZDC2 having a diameter of 1.0 mm and a length of about 3 mm are soldered to the carriage 3 made of ZDC2 in predetermined positions. Moreover, the light reception element portion 10 is a portion in which four cylinders 20b made of ZDC2 having a diameter of 1.0 mm and a length of about 3 mm are soldered to the light reception element holder 102 made of ZDC2 in a predetermined position, and the window 103 is bonded thereto. As described using FIG. 2 in the preceding embodiment, the light reception element portion 10 is fixed to the carriage 3 by applying and curing the adhesive 20z using the dispenser so that the end portions of the cylinders 20a and 20b sufficiently enter the inner portion thereof. As the dispenser, AD2000C manufactured by IWASHITA INSTRUMENT COMPANY is used, the air pressure thereof 0.4 Pa, and time for one shot is 0.2 seconds. As the adhesive 20z, an ultraviolet-curable adhesive UVX 890 manufactured by Denka is used. As an ultraviolet irradiator for optically curing the adhesive 20z applied so as to include the end portion of the cylinder 20a and the end portion of the cylinder 20b, a spot cure SP-V manufactured by Ushio Electric is used. Moreover, the distance from the optical path head to the adhesive 20z is about 30 mm, and the light exposure is performed for the time when the light exposure amount upon being measured by a UV actinometer UIT 250 manufactured by Ushio Electric is 6,000 mJ/cm².

In the first embodiment, the number of shots from the dispenser is 3, the application amount of the adhesive 20z in that case is 7.1 mg, and the volume of the adhesive 20z to be calculated from the application amount is 4.5 mm³. At this time, the application shape of the adhesive 20z before performing the photocuring is an approximately spherical shape having a diameter of about 4.0 mm, and the sphericity is 90%. Moreover, the distance, by which photocuring of the adhesive 20z is performed and the center of the spot (hereinafter, referred to as “an optical spot”) to be formed on the window 103 by return laser light is moved immediately after removing the chucking jig supporting the light reception element portion 10, is about 0.2 μm. Furthermore, in this manner, after preserving the optical pickup 2 (see FIG. 1) in which the light reception element portion 10 is fixed to the carriage 3 in the atmosphere of 60° C. for 100 hours, the distance, by which the center of the optical spot is moved from the position before removing the chucking jig, is 0.5 μm.

### Second Embodiment

The light reception element portion 10 is fixed to the carriage 3 using basically the same method as the preceding first embodiment, but the cylinders 20a and 20b of the present second embodiment are made of ZDC2 having a diameter of 0.5 mm and a length of about 3 mm. The number of shots from the dispenser is two, the application amount of the adhesive 20z in that case is 4.4 mg, and the volume of the adhesive 20z to be calculated from the application amount is 2.7 mm³. At this time, the application shape of the adhesive 20z before performing the photocuring is an approximately spherical shape having a diameter of about 2.0 mm, and the sphericity is 95%. Moreover, the distance, by which the photocuring of the adhesive 20z is performed and the center of the optical spot to be formed on the window 103 is moved immediately after removing the chucking jig supporting the light reception element portion 10, is about 0.2 μm. Furthermore, in this manner, after preserving the optical pickup 2 (see FIG. 1) in which the light reception element portion 10 is fixed to the carriage 3 in the atmosphere of 60° C. for 100 hours, the distance, by which the center of the optical spot is moved from the position before removing the chucking jig, is 0.7 μm.

### Third Embodiment

The light reception element portion 10 is fixed to the carriage 3 using basically the same method as the preceding first embodiment, but the cylinders 20a and 20b of the present third embodiment are made of ZDC2 having a diameter of 3.0 mm and a length of about 3 mm. The shot numbers of the dispenser are 3 shots, the application amount of the adhesive 20z in that case is 7.1 mg, and the volume of the adhesive 20z to be calculated from the application amount is 4.5 mm³. At this time, the application shape of the adhesive 20z before performing the photocuring is an approximately spherical shape having a diameter of about 4.0 mm, and the sphericity is 85%. Moreover, the distance, by which the photocuring of the adhesive 20z is performed and the center of the optical spot to be formed on the window 103 is moved immediately after removing the chucking jig supporting the light reception element portion 10, is about 0.1 μm. Furthermore, in this manner, after preserving the optical pickup 2 (see FIG. 1) in which the light reception element portion 10 is fixed to the carriage 3 in the atmosphere of 60° C. for 100 hours, the distance, by which the center of the optical spot is moved from the position before removing the chucking jig, is 0.4 μm.

### Fourth Embodiment

The light reception element portion 10 is fixed to the carriage 3 using basically the same method as the preceding first embodiment, but the cylinders 20a and 20b of the present fourth embodiment are made of ZDC2 having a diameter of 0.5 mm and a length of about 3 mm. The shot numbers of the dispenser are 10 shots, the application amount of the adhesive 20z in that case is 22.4 mg, and the volume of the adhesive 20z to be calculated from the application amount is 14.0 mm³. At this time, the application shape of the adhesive 20z before performing the photocuring is an approximately spherical shape having a diameter of about 4.2 mm, and the sphericity is 85%. Moreover, the distance, by which the photocuring of the adhesive 20z is performed and the center of the optical spot to be formed on the window 103 is moved immediately after removing the chucking jig supporting the light reception element portion 10, is about 0.3 μm. Furthermore, in this manner, after preserving the optical pickup 2 (see FIG. 1) in which the light reception element portion 10 is fixed to the carriage 3 in the atmosphere of 60° C. for 100 hours, the distance, by which the center of the optical spot is moved from the position before removing the chucking jig, is 1.2 μm.

### Fifth Embodiment

The light reception element portion 10 is fixed to the carriage 3 using basically the same method as the preceding first embodiment, but the cylinders 20a and 20b of the present fifth embodiment are made of ZDC2 having a diameter of 3.0 mm and a length of about 3 mm. The shot numbers of the dispenser are 21 shots, the application amount of the adhesive 20z in that case is 47.2 mg, and the volume of the adhesive 20z to be calculated from the application amount is 29.5 mm³. At this time, the application shape of the adhesive 20z before performing the photocuring is an approximately spherical shape having a diameter of about 6.1 mm, and sphericity is 85%. Moreover, the distance, by which the photocuring of the adhesive 20z is performed and the center of the optical spot to be formed on the window 103 is moved immediately after removing the chucking jig supporting the light reception element portion 10, is about 0.5 μm. Furthermore, in this manner, after preserving the optical pickup 2 (see FIG. 1) in which the light reception element portion 10 is fixed to the carriage 3 in the atmosphere of 60° C. for 100 hours, the distance, by which the center of the optical spot is moved from the position before removing the chucking jig, is 1.5 μm.

### FIRST COMPARATIVE EXAMPLE

Unlike the first embodiment, as described using FIG. 4, the light reception element portion 10 is fixed to the carriage 3 only using the adhesive 21. That is, the light reception element portion 10 is fixed to the carriage 3 by applying and curing the ultraviolet-curable adhesive 21 using the dispenser so as to fill the gap between the end portion of the carriage 3 and the end portion of the light reception element holder 102. As the dispenser, AD2000C manufactured by IWASHITA INSTRUMENT COMPANY is used, the air pressure thereof 0.4 Pa, and time for one shot is 0.2 seconds. As the adhesive 20z, an ultraviolet-curable adhesive UVX 890 manufactured by Denka is used. As an ultraviolet irradiator for optically curing the adhesive 20z applied to the cylinders 20a and 20b, a spot cure SP-V manufactured by Ushio Electric is used. Moreover, the distance from the optical path head to the adhesive 21 is about 30 mm, and the light exposure is performed for the time when the light exposure amount upon being measured by a UV actinometer UIT 250 manufactured by Ushio Electric is 6,000 mJ/cm².

In the first comparative example, the shot numbers of the dispenser are 14 shots. At this time, the distance, by which the photocuring of the adhesive 21 is performed and the center of the optical spot to be formed on the window 103 by return light of laser is moved immediately after removing the chucking jig supporting the light reception element portion 10, is about 3.0 μm or more (un-measurable). Furthermore, in this manner, the test of obtaining after preserving the optical pickup 2 (see FIG. 1) in which the light reception element portion 10 is fixed to the carriage 3 in the atmosphere of 60° C. for 100 hours, the distance, by which the center of the optical spot is moved from the position before removing the chucking jig, is stopped.

### SECOND COMPARATIVE EXAMPLE

The light reception element portion 10 is fixed to the carriage 3 using basically the same method as the preceding first embodiment, but the cylinders 20a and 20b of the present second comparative example are made of ZDC2 having a diameter of 0.2 mm and a length of about 3 mm. The shot numbers of the dispenser are 1 shot, the application amount of the adhesive 20z in that case is 2.2 mg, and the volume of the adhesive 20z to be calculated from the application amount is 1.37 mm³. At this time, the application shape of the adhesive 20z before performing the photocuring is an approximately spherical shape having a diameter of about 1.3 mm, and sphericity is 95%. Moreover, the distance, by which the photocuring of the adhesive 20z is performed and the center of the optical spot to be formed on the window 103 is moved immediately after removing the chucking jig supporting the light reception element portion 10, is about 1.7 μm. Furthermore, in this manner, after preserving the optical pickup 2 (see FIG. 1) in which the light reception element portion 10 is fixed to the carriage 3 in the atmosphere of 60° C. for 100 hours, the distance, by which the center of the optical spot is moved from the position before removing the chucking jig, is 2.9 μm.

### THIRD COMPARATIVE EXAMPLE

The light reception element portion 10 is fixed to the carriage 3 using basically the same method as the preceding first embodiment, but the cylinders 20a and 20b of the present third comparative example are made of ZDC2 having a diameter of 4.0 mm and a length of about 3 mm. The shot numbers of the dispenser are 25 shots, the application amount of the adhesive 20z in that case is 55.0 mg, and the volume of the adhesive 20z to be calculated from the application amount is 34.4 mm³. At this time, the application shape of the adhesive 20z before performing the photocuring is an approximately spherical shape having a diameter of about 6.6 mm, and sphericity is 70%. Moreover, the distance, by which the photocuring of the adhesive 20z is performed and the center of the optical spot to be formed on the window 103 is moved immediately after removing the chucking jig supporting the light reception element portion 10, is about 2.0 μm. Furthermore, in this manner, after preserving the optical pickup 2 (see FIG. 1) in which the light reception element portion 10 is fixed to the carriage 3 in the atmosphere of 60° C. for 100 hours, the distance, by which the center of the optical spot is moved from the position before removing the chucking jig, is 3.0 μm or more (un-measurable).

### FOURTH COMPARATIVE EXAMPLE

The light reception element portion 10 is fixed to the carriage 3 using basically the same method as the preceding first embodiment, but the cylinders 20a and 20b of the present fourth comparative example are made of ZDC2 having a diameter of 0.5 mm and a length of about 3 mm. The shot number of the dispenser is 1 shot, the application amount of the adhesive 20z in that case is 2.2 mg, and the volume of the adhesive 20z to be calculated from the application amount is 1.37 mm³. At this time, the application shape of the adhesive 20z before performing the photocuring is an approximately spherical shape having a diameter of about 1.3 mm, and sphericity is 83%. Moreover, the distance, by which the photocuring of the adhesive 20z is performed and the center of the optical spot to be formed on the window 103 is moved immediately after removing the chucking jig supporting the light reception element portion 10, is about 0.9 μm. Furthermore, in this manner, after preserving the optical pickup 2 (see FIG. 1) in which the light reception element portion 10 is fixed to the carriage 3 in the atmosphere of 60° C. for 100 hours, the distance, by which the center of the optical spot is moved from the position before removing the chucking jig, is 2.4 μm.

### FIFTH COMPARATIVE EXAMPLE

The light reception element portion 10 is fixed to the carriage 3 using basically the same method as the preceding first embodiment, but the cylinders 20a and 20b of the present fifth comparative example are made of ZDC2 having a diameter of 3.0 mm and a length of about 3 mm. The shot numbers of the dispenser are 2 shots, the application amount of the adhesive 20z in that case is 4.3 mg, and the volume of the adhesive 20z to be calculated from the application amount is 2.7 mm³. At this time, the application shape of the adhesive 20z before performing the photocuring is an approximately spherical shape having a diameter of about 1.9 mm, and sphericity is 85%. Moreover, the distance, by which the photocuring of the adhesive 20z is performed and the center of the optical spot to be formed on the window 103 is moved immediately after removing the chucking jig supporting the light reception element portion 10, is about 1.1 μm. Furthermore, in this manner, after preserving the optical pickup 2 (see FIG. 1) in which the light reception element portion 10 is fixed to the carriage 3 in the atmosphere of 60° C. for 100 hours, the distance, by which the center of the optical spot is moved from the position before removing the chucking jig, is 2.3 μm.

### SIXTH COMPARATIVE EXAMPLE

The light reception element portion 10 is fixed to the carriage 3 using basically the same method as the preceding first embodiment, but the cylinders 20a and 20b of the present sixth comparative example are made of ZDC2 having a diameter of 0.5 mm and a length of about 3 mm. The shot numbers of the dispenser are 15 shots, the application amount of the adhesive 20z in that case is 33.0 mg, and the volume of the adhesive 20z to be calculated from the application amount is 20.6 mm³. At this time, the application shape of the adhesive 20z before performing the photocuring is an approximately spherical shape having a diameter of about 5.1 mm, and sphericity is 75%. Moreover, the distance, by which the photocuring of the adhesive 20z is performed and the center of the optical spot to be formed on the window 103 is moved immediately after removing the chucking jig supporting the light reception element portion 10, is about 1.5 Furthermore, in this manner, after preserving the optical pickup 2 (see FIG. 1) in which the light reception element portion 10 is fixed to the carriage 3 in the atmosphere of 60° C. for 100 hours, the distance, by which the center of the optical spot is moved from the position before removing the chucking jig, is 2.8 μm.

### SEVENTH COMPARATIVE EXAMPLE

The light reception element portion 10 is fixed to the carriage 3 using basically the same method as the preceding first embodiment, but the cylinders 20a and 20b of the present seventh comparative example are made of ZDC2 having a diameter of 3.0 mm and a length of about 3 mm. The shot numbers of the dispenser are 25 shots, the application amount of the adhesive 20z in that case is 55.0 mg, and the volume of the adhesive 20z to be calculated from the application amount is 34.4 mm³. At this time, the application shape of the adhesive 20z before performing the photocuring is an approximately spherical shape having a diameter of about 6.7 mm, and sphericity is 70%. Moreover, the distance, by which the photocuring of the adhesive 20z is performed and the center of the optical spot to be formed on the window 103 is moved immediately after removing the chucking jig supporting the light reception element portion 10, is about 1.8 μm. Furthermore, in this manner, after preserving the optical pickup 2 (see FIG. 1) in which the light reception element portion 10 is fixed to the carriage 3 in the atmosphere of 60° C. for 100 hours, the distance, by which the center of the optical spot is moved from the position before removing the chucking jig, is 3.0 μm (un-measurable).

The test results shown in the above embodiments and comparative examples will be summarized as below.

(Table 1) shows the distance by which the center of the optical spot is moved from the position before removing the chucking jig after the light reception element portion is fixed to the carriage of the optical pickup by the method shown in the present embodiments and the optical pickup is preserved in the atmosphere of 60° C. for 100 hours. That is, it indicates the movement amount of the light reception element from the original position. The application volume of the adhesive is changed for each diameter of the cylinder.

TABLE 1

| Movement amount | | | | | | | | |
|---|---|---|---|---|---|---|---|---|
| of light reception | | Volume of Application of Adhesive (mm³) | | | | | | |
| element (μm) | | 1.37 | 2.7 | 4.5 | 14 | 20.6 | 29.5 | 34.4 |
| Diameters | 0.2 | 2.9 | | | | | | |
| of | 0.5 | 2.4 | 0.7 | | 1.2 | 2.8 | | |
| cylinders | 1 | | | 0.5 | | | | |
| | 3 | | 2.3 | 0.4 | | | 1.5 | Equal |
| | | | | | | | | To Or |
| | | | | | | | | More |
| | | | | | | | | Than |
| | | | | | | | | 3 |
| | 4 | | | | | | | Equal |
| | | | | | | | | To Or |
| | | | | | | | | More |
| | | | | | | | | Than |
| | | | | | | | | 3 |

In the present embodiments, if the movement amount (μm) of the light reception element portion 10 shown in FIG. 1 is equal to or less than 2 μm form the position before removing the chucking jig, the reading and the writing of information to the optical disc can be executed. Meanwhile, when the movement amount of the light reception element exceeds 2 μm, in some cases, reading and writing of information to the optical disc cannot be executed. Upon applying this to (Table 1), concerning whether or not the reading and the writing of information to the optical disc are performed, it is evident that the critical values of the upper limit and the lower limit exist between the diameters of the protrusions of the cylinders 20a and 20b shown in FIG. 2 and the application amount of the adhesive. That is, if a portion surrounded by the alternating long and short dashed line is in (Table 1), it is possible to make the movement of the light reception element portion 10 in FIG. 2 from the position before removing the chucking jig equal to or less than 2 μm. Herein, it is first understood from (Table 1) that the diameters of the cylinders 20a and 20b in FIG. 2 for satisfying the condition are both within the range from 0.5 mm to 3.0 mm. In the diameters of the cylinders 20a and 20b, the amount of the adhesive that can make the movement amount of the light reception element from the position before removing the chucking jig equal to or less than 2 μm is clear from this.

(Table 2) is one in which the test result concerning the lower limit of the application amount of the adhesive within the range from 0.5 mm to 3.0 mm of the diameters of the cylinders 20a and 20b in FIG. 2 is selected from (Table 1).

TABLE 2

| Movement amount | | Volume of | | |
|---|---|---|---|---|
| of light reception | | Application of Adhesive (mm³) | | |
| element (μm) | | 1.37 | 2.7 | 4.5 |
| Diameters | 0.5 | 2.4 | 0.7 | |
| of | 1 | | | 0.5 |
| cylinders | 3 | | 2.3 | 0.4 |

In (Table 2), when the diameter of the cross-section of the circular protrusion is x and the volume of the applied adhesive is S, it is clear that the conditions in which the movement amount of the light reception element is equal to or less than 2 μm are indicated by (formula 2) as below.

n(x/2+0.5)̂(1/2)<=S (formula 2)

However, the unit of x is mm, and the unit of S is mm³.

(Table 3) is one in which the test result concerning the upper limit of the application amount of the adhesive within the range from 0.5 mm to 3.0 mm of the diameters of the cylinders 20a and 20b in FIG. 2 is selected from (Table 1).

TABLE 3

| Movement amount | | Volume of | | | |
|---|---|---|---|---|---|
| of light reception | | Application of Adhesive (mm³) | | | |
| element (μm) | | 14 | 20.6 | 29.5 | 34.4 |
| Diameters | 0.5 | 1.2 | 2.8 | | |
| of | 1 | | | | |
| cylinders | 3 | | | 1.5 | Equal |
| | | | | | To Or More |
| | | | | | Than 3 |

Meanwhile, in the portion surrounded by the alternating long and short dashed line, the sphericity of the applied adhesive 20z in FIG. 2 is equal to or greater than 80% from the test result shown in the embodiments and the comparative examples. It is considered that this is because, when the application amount of the adhesive 20z is small, the sphericity can be kept high by the surface tension of the adhesive 20z, but when the application amount of the adhesive 20z is great, the application shape is changed due to the dead weight of the adhesive 20z, and the sphericity cannot be kept high.

Furthermore, in order to secure the strength that supports the light reception element portion 10 in FIG. 2, there is a need for a certain degree of size in the cylinders 20a and 20b. However, conversely, when the diameters of the cylinders 20a and 20b are increased, the amount of the adhesive 20z is also increased, whereby the sphericity cannot be kept high.

Owing to this, it is assumed that the upper limit of the application amount of the adhesive 20z in FIG. 2 is represented by logarithm relative to the diameter of the cylinder 20a. When the diameter of the cylinder 20a or 20b is x and the volume of the adhesive 20z is S, it is clear that the condition, in which the movement amount of the light reception element portion 10 is equal to or less than 2 μm, is indicated (formula 3) as below.

S<=201 log(x)+20 (formula 3)

However, the unit of x is mm and the unit of S is mm³.

In this manner, upon summarizing the approximation formula concerning the diameter of the cylinders 20a and 20b shown in the above (formula 1) and the lower end of the application amount of the adhesive 20z, and the approximation formula concerning the upper limit shown in the above (formula 2), (formula 4) is obtained as below.

π(x/2+0.5)̂(1/2)<=S<=201 log(x)+20 (formula 4)

The range of the diameters of the cylinders 20a and 20b of FIG. 2 and the application amount of the adhesive 20z indicated in this formula, that is, the portion surrounded by the alternating long and short dashed line in (Table 1) can make the movement amount of the light reception element portion 10 in FIG. 2 from the position before removing the chucking jig equal to or less than 2 μm.

According to the embodiments as above, by the configuration mentioned above, it is possible to raise the position fixing accuracy of the optical component such as the light reception element constituting the optical pickup apparatus. Thus, even when the optical pickup is used for a long period and subjected to environment changes of temperature or the like, the function of the optical pickup can be reliably realized without causing the positional deviation in the optical path of the laser light, and it is possible to provide a practical optical pickup apparatus.

In addition, in the present embodiments, the carriage holding the light reception element portion 10 was described as an example, but the application scope of the present invention is not limited thereto. For example, in FIG. 1, the present invention is applied to a case where, besides the light reception element portion 10, the optical components such as the prisms 9a and 9b, the collimator lenses 12 and 15, the critical angle prism 13, the beam splitter 14, the concave lens 16, and the convex lens 17 are installed on a holder (not shown) and the carriage 3 holds the holder,. In addition, the present invention is also applied to a case where the optical components are held in a member situated in the middle position without being directly held in the carriage 3. For example, when the distance between the concave lens 16 and the convex lens 17 is variable by a movement mechanism (not shown), the concave lens 16 and the convex lens 17 are held in the movement mechanism. At that time, the holding method according to the present invention is applied between the concave lens 16 or the convex lens 17 and a movement mechanism (not shown). Furthermore, depending on the design method of the optical disc recording and playback apparatus, in some cases, a part of the optical components mentioned above is held on a base table of the optical disc recording and playback apparatus with the carriage movably mounted thereon, but not on the holding portion that is movable like the carriage 3 in FIG. 1. Even in such a case, the present invention is applied to a case where the optical components are installed on a holder (not shown) and the carriage 3 holds the holder.

This application claims the benefit of Japanese Patent application No. 2010-284519 filed on Jul. 12, 2010, the entire contents of which are incorporated herein by reference.

What is claimed is:

1. An optical pickup apparatus, comprising:
a light reception element portion;
a carriage that holds the light reception element portion;
a first adhesive application portion that has a cylindrical shape and is included in the light reception element portion and includes a cross-sectional surface in a direction opposite to the light reception element; and
a second adhesive application portion that has a cylindrical shape and is included in the carriage and includes a cross-sectional surface in a direction opposite to the carriage,
wherein the cross-sectional surface of the first adhesive application portion is opposite to the cross-sectional surface of the second adhesive application portion, and the first cross-sectional surface is separated from the second cross-sectional surface, and
the cross-sectional surface of the first adhesive application portion and the cross-sectional surface of the second adhesive application portion are fixed to each other by an adhesive in a spherical shape, and at least a part of the first and second adhesive application portions is included in the adhesive.

2. The optical pickup apparatus according to claim 1, wherein a diameter of a cylinder cross-sectional surface included in the first and second adhesive application portions is equal to or greater than 0.5 mm and equal to or less than 3.0 mm.

3. The optical pickup apparatus according to claim 2, wherein, when the diameter of the cylinder cross-sectional surface included in the first and second adhesive application portions is x and the volume of the adhesive is S, the volume S is in the range indicated by π(x/2+0.5)̂(1/2)≦S≦201 log(x)+20.

4. The optical pickup apparatus according to claim 3, wherein, concerning axes passing through a center of the adhesive of the spherical shape, when a ratio between a length of the shortest axis and a length of the largest axis is indicated as sphericity, the sphericity of the adhesive of the spherical shape before performing photocuring is equal to or greater than 85%.

5. The optical pickup apparatus according to claim 1, wherein, in the first and second adhesive application portions, a length of a portion included in the adhesive of the spherical shape is equal to or greater than 0.5 mm and equal to or less than 1.0 mm.

6. An optical disc recording and playback apparatus on which the optical pickup apparatus according to claim 1 is mounted to perform playback or recording of an optical disc.

7. An optical pickup apparatus comprising:
an optical component that transmits, refracts or receives light emitted from a light source;
an optical portion that holds the optical component;
a holding portion that holds the optical portion;
a first adhesive application portion that has a cylindrical shape and is included in the optical portion and includes a cross-sectional surface in a direction opposite to the optical portion; and
a second adhesive application portion that has a cylindrical shape that is included in the holding portion and includes a cross-sectional surface in a direction opposite to the holding portion,
wherein the cross-sectional surface of the first adhesive application portion is opposite to the cross-sectional surface of the second adhesive application portion, and the first cross-sectional surface is separated from the second cross-sectional surface, and
the cross-sectional surface of the first adhesive application portion and the cross-sectional surface of the second adhesive application portion are fixed to each other by an adhesive in a spherical shape, and at least a part of the first and second adhesive application portions is included in the adhesive.

8. An optical disc recording and playback apparatus on which the optical pickup apparatus according to claim 7 is mounted to perform playback or recording of an optical disc.
